(19) United States
(12) Patent Application Publication
(10) Pub. No.: US 2005/0282051 A1
(43) Pub. Date: Dec. 22, 2005

(54) Integrated honeycomb solid electrolyte fuel cells

(76) Inventor: Zhigang Zhou, Temple City, CA (US)

Correspondence Address: Zhigang Zhou, 5651 Sultana Ave. #C, Temple City, CA, 91780, US

(21) Appl. No.: 10/928,489

(22) Filed: Aug. 27, 2004

Related U.S. Application Data
(60) Provisional application No. 60/481,302, filed on Aug. 28, 2003.

(51) Int. Cl. H01M 8/24; H01M 8/10; B01J 35/04

(52) U.S. Cl. 429/32; 429/38; 422/222

(57) ABSTRACT

The invention of solid electrolyte fuel cell power generating system integrates heat exchange, combustion, exhaust recycle, steam/fuel conditioning, fuel reforming, water condensing, water drainage, or water recycle into monolithic honeycomb structures. Manifolds serve as honeycomb multiple channel group gas passageways between channels within a honeycomb or between honeycombs. The said manifolds also serve as electrical interconnect or electrical power leads between honeycomb channels within said honeycomb structure or between honeycomb fuel cell structures. Honeycomb fuel cells can be stacked by utilizing the said manifolds. The honeycomb fuel cell system converses chemical energy of a fuel gas into electrical energy by an electrochemical process. The said integrated honeycomb fuel cell system design demonstrates simple, robust, and integrated mechanical structure and may enhance power efficiency and low cost.

### CROSS REFERENCE TO RELATED APPLICATIONS

This application is a continuation-in-part of U.S. provisional application No. 60/481,302 filed on Aug. 28, 2003 by Zhou with the title “Integrated Fuel Cell Power Generating System”.

### BACKGROUND OF INVENTION

Fuel cells are electrochemical devices that convert chemical energy of a reaction directly into electrical energy. Fuel cells can be divided into the following five categories based on electrolyte materials used: (1) solid oxide fuel cell (SOFC); (2) proton exchange membrane fuel cell (PEFMC); (3) molten carbonate fuel cell (MCFC); (4) phosphoric acid fuel cell (PAFC); and (5) alkaline fuel cell (AFC). Among these types of fuel cells, SOFC and PEMFC utilize solid electrolytes. In general, the solid electrolytes can be tubular, planar, or monolithic. I use solid electrolyte fuel cell to refer SOFC or PEMFC in the following text.

For solid oxide fuel cells, tubular and planar types are commonly used. Tubular fuel cells are structurally robust. Planar fuel cells offer higher power density but less favorable in mechanical strength compared with tubular fuel cells. It is desirable to have a fuel cell design which may combine the advantages from both tubular and planar fuel cells. A monolithic honeycomb fuel cell structure may combine the advantages of high power density and structural robustness from planar fuel cells and tubular fuel cells, respectively.

A typical solid oxide fuel cell generates electrical power by utilizing electrochemical reactions between fuel, such as, hydrogen or gaseous hydrocarbons, and oxidant, such as air. Its typical reactions are: (1) HC (Hydrocarbons)+H₂O→CO+H₂; and (2) H₂+O₂→H₂O. Reaction (1) is a hydrocarbon reforming reaction. Reaction (2) is a typical electrochemical oxidation reaction which results in power generation.

Because of low mobility of charge carrier, O²⁻, in solid oxide electrolyte, such as, Y₂O₃ doped ZrO₂, SOFC have to be operated at high temperatures, in a range of 600-1100° C. High temperature is required for both fuel reforming and electrochemical reactions. Feed gases including fuels and oxidants are required to be preheated before going through electrochemical reactions. Feed gases can be preheated by: (1) generating and exchanging heat from combustion of unconverted hydrocarbons contained in the exhaust gases; and (2) heat exchange between exhaust gases and feed gases. It is desirable to incorporate heat exchangers and combustors to provide efficient feed gas preheating. For honeycomb fuel cell structures, it is required to have multiple channels. In addition to oxidant and fuel channels, for example, more channels are needed for fuel reformation, exhaust gas recycle, and feed gas preheating.

PEMFC can operate at a relatively low temperature, ˜80° C., because of high mobility of proton, H⁺, in polymer electrolytes. This enables the fuel cell to reach its operating temperature quickly. In addition to hydrogen, methanol can also be used in PEMFC as a fuel which is referred to as “direct methanol fuel cells” (DMFC). The key component for both PEMFC and DMFC is the material of proton electrolyte membranes. Presently, hydrated perfluorosulfonic acid based materials are used for PEMFC and DMFC. This type of materials has relatively high proton conductivity and excellent chemical, mechanical, thermal stability in the hydrated state. However, when temperature reaches above 80° C., proton conductivity reduces and methanol fuel crossover increases. Because of high cost of the membrane materials, composites containing hydrated perlouorosulfonic acid materials are made for the fuel cell applications with improved mechanical strength and lower costs. However, the membrane materials and the related composite materials are not mechanically stiff enough to be used alone without additional supporting structures which are usually made of precious metals. It is desirable to have reinforced composite proton exchange membrane capable of withstanding all the various load conditions experienced during fuel cell operations. Using such PEM as structural load carrier components of the PEMFC systems may largely reduce overall weight and cost of the PEMFCs. Furthermore, a honeycomb may be a good structure to meet the requirements of PEMFCs.

The typical electrochemical reactions of PEMFCs are: (1) Anode: H₂→2H⁺+2e⁻; and (2) Cathode: 1/2O₂+2H⁺+2e⁻→H₂O. Then the overall electrochemical reaction is H₂+1/2O₂→H₂O. This is an exothermic reaction. Rejected heat can not be utilized for cogeneration. Temperature increase may reduce electrolyte ohmic resistance and CO chemisorption which is an endothermic reaction. However, this is limited by high vapor pressure of water in the electrolytes which ion conductivity is susceptible to dehydration. In the PEMFCs, water is not produced as steam but as liquid. Water balance is very import. If water is surplus, electrodes will flood which prevent gas from being diffused to electrodes. If water is deficient, electrolytes will be dehydrated. Ionic conductivity decreases and cell performance degrades. It is desirable to have a built in heat and water management system for the PEMFCs. Honeycomb structure with plural channels may be suitable for the PEMFCs. In addition to oxidant and fuel channels, for example, extra channels are needed for water management, fuel reformation, or feed gas preheating for honeycomb structure fuel cells.

A honeycomb structure fuel cell or honeycomb fuel cell stacks may provide improved mechanical integrity and lower costs for solid electrolyte fuel cells. The concept of using honeycomb structure for monolithic solid oxide fuel cells is well known. However, to integrate multiple functions, such as, fuel reforming, feed gas preheating, water management, exhaust gas recycle, honeycomb manifolds with multiple groups of channels is one of the key elements. The multiple channel groups may include but are not limited to the groups of fuel gas, oxidant gas, exhaust gas, and water steam. The above said manifolds may be applied to honeycomb solid electrolyte fuel cell stacks which include SOFC or PEMFC and honeycomb fuel reformers as well.

### SUMMARY OF INVENTION

In accordance with the invention, the said manifold designs and designs of fuel cell stacks based on the said manifolds are provided. It is an object of the present invention to utilize manifolds for providing plural gas passageways to honeycomb reformers or honeycomb solid electrolyte fuel cells including SOFC and PEMFC. The said manifolds maintain the gas passageways by connecting or grouping, in serial or parallel, the alternated channels of a honeycomb structure. These said honeycomb channels are formed by interconnecting walls which are parallel or non-intervened, extended from one face to the other of the said honeycomb. Each group of the channels can be assigned to but not limited to fuel gas, oxidant gas, exhaust gas, or water steam.

It is an object of the present invention to utilize honeycomb manifolds for honeycomb fuel cell stakes or honeycomb fuel reformer stacks. Honeycomb manifolds interconnect multiple channel groups, usually more than two, gas passageways within a honeycomb structure, between honeycomb structures in a said stack, or with gas or water inlets or outlets. The said honeycomb manifolds provide gas passageway interconnections among the channels within a channel group of a honeycomb, in serial or parallel or both. The said manifolds provide channel interconnections between/among channel groups of a honeycomb, in serial or parallel or both. One of the examples of this feature is exhaust channel group that may interconnect fuel outlet channels and oxidant outlet channels. Such a channel group with mixed fuel and oxidant exhausts can be used for combustion in order to preheat feed gases or solid oxide fuel cell assembly itself. The said honeycomb manifold may also provide gas passageways between or among the same or different channel groups from different honeycombs in the stack, in serial or parallel or both.

It is an object of the present invention to integrate a heat exchanger, a combustor, a fuel reformer, a water recycler, or any combinations including the above mentioned in the honeycomb fuel cells or honeycomb fuel cell stacks. The integration can be within single honeycomb fuel cells or a stack of multiple honeycomb fuel cells or a combination of both. In SOFCs, fuel and oxidant outlets may be grouped into exhaust channels and connected to combustor channels. The heat generated from the combustion can be used for preheating the system and the feed gases. After the system and feed gases are warmed up, fuel gas may pass through reformer for partial or complete conversion of hydrocarbons to hydrogen or smaller hydrocarbons or for surlpher depletion. Heat management for preheating feed gas or cooling the fuel cell system and water management for fuel conditioning are important in PEMFCs. These features may be integrated into the honeycomb PEMFCs or honeycomb PEMFC stacks.

It is another object of the present invention to interconnects, via a manifold, electrodes between different channels either within a single honeycomb, between multiple honeycombs, or with electrical power leads, in series or parallel. Configurations of electrolyte, anode, cathode, and interconnect for a honeycomb fuel cell are also provided in this invention. Honeycomb manifolds may provide both gas passageways and electrical interconnections for honeycomb fuel cells.

In carrying out the above objects of the present invention, a honeycomb fuel cell system is provided that integrates combustor, heat exchanger, reformer, fuel humidification, water drainage, exhaust recycle, water recycle, or in monolithic fuel cells via manifolds. The honeycomb fuel cell system of the present invention involves a fuel cell stack for conversion of chemical energy of a fuel gas into electrical energy by an electrochemical process.

Other objects and advantages of the invention will become apparent upon reading the following detailed description and appended claims, and upon reference to the accompanying drawings.

### BRIEF DESCRIPTION OF DRAWINGS

FIG. 1 is a schematic diagram of an embodiment of solid oxide fuel cell power generating system of the invention.

FIG. 2(a) to FIG. 2(d) Illustrate honeycomb structures with square cells and hexagonal cells.

FIG. 3(a) to FIG. 3(d) Illustrate equivalent circuits corresponding to honeycomb structures illustrated in FIG. 2(a) to FIG. 2(d), respectively.

FIG. 4(a) to FIG. 4(k) Illustrate honeycomb structure manifolds.

FIG. 5 Illustrates a honeycomb manifold which provides electrical interconnect and stack support for segmented-cell-in-series.

FIG. 6(a)-FIG. 6(b) show electrical interconnection between two fuel cells via a manifold.

FIG. 7(a)-FIG. 7(b) show electrical interconnection between two fuel cells via a manifold.

### DETAILED DESCRIPTION

The honeycomb solid oxide fuel cell power generating system of the invention comprises:

a) a honeycomb fuel cell structure containing electrolyte, an anode, a fuel inlet, a depleted fuel exhaust gas outlet, a fuel source in connection with a fuel inlet, a cathode, an oxidant inlet, an spent oxidant exhaust gas outlet, and an oxidant source in connection with oxidant inlet;

b) a honeycomb structure integrated with a heat exchanger or a combustor via manifold with fuel cell;

c) a means of recycling exhaust gas from depleted fuel exhaust gas outlet to heat exchanger in connection with fuel exhaust outlet and combustor in connection with heat exchanger; and

d) a means of recycling exhaust gas from spent oxidant outlet to heat exchanger that is in connection with oxidant exhaust outlet.

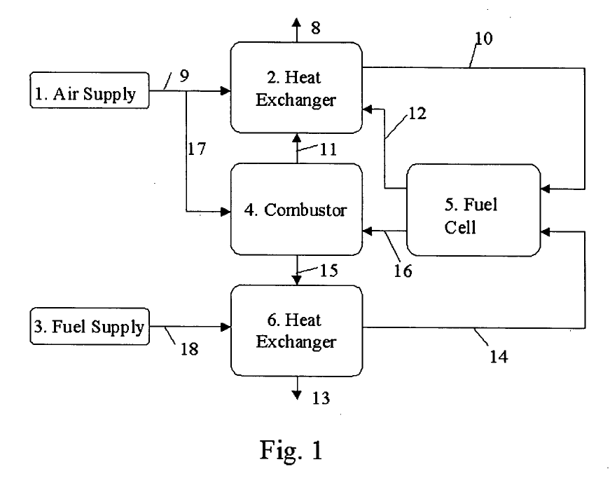

FIG. 1 shows a schematic diagram of integrated fuel cell power generating system of the invention. The system is preferably operated at temperatures between 600-1100°C. The air supply 1 is connected to heat exchanger 2 through the line 9. The supplied air is preheated by high temperature exhaust gas through heat exchanger 2 and combustor 4 which utilizes unspent fuel from fuel cell 5 through connection 16. The preheated air is supplied to fuel cell 5, through connection 10. Meanwhile, fuel supply 3 is connected to heat exchanger 7 through line 18. Fuel is preheated in heat exchanger 7 and is further preheated by combustor 4 which burns unspent fuel exhaust from the fuel cell 5. The preheated fuel is then provided to fuel cell 5 in which hydrocarbon fuel will be reformed and/or directly oxidized as follows:
HC+O₂→H₂+CO₂
H₂+O₂→H₂O
and/or
HC+O₂→H₂O+CO₂

The hydrocarbon can be methane, propane, etc. The unspent fuel exhaust from fuel cell 5 and feed to combustor 4 where the unspent fuel will be combusted exothermically. The heat generated from the combustion is transferred to heat exchanger 2 and 6 for preheating feed gases to support fuel cell endothermic reforming reaction.

The exhaust from combustor 4 goes through heat exchanger 2 and 6 for preheating and then is released to environment through exhaust lines 8 and 13 as shown in FIG. 1.

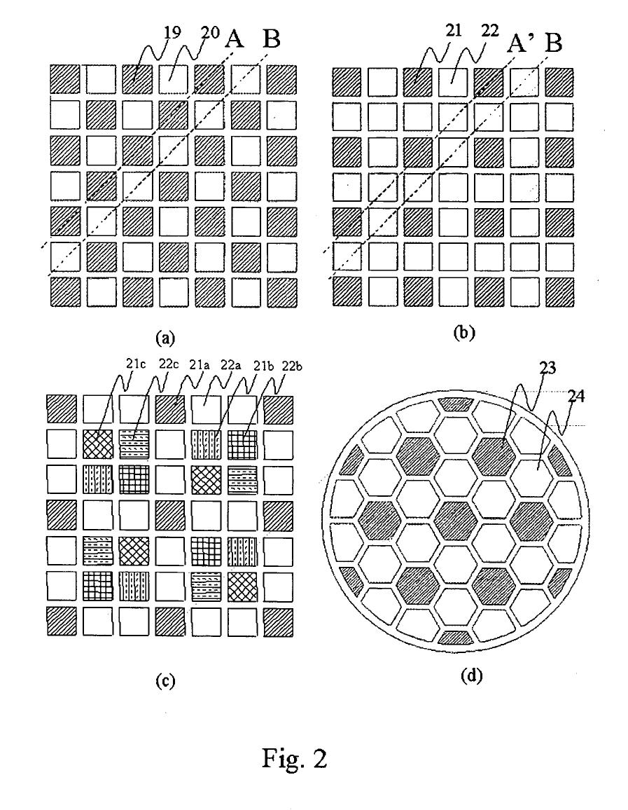

FIG. 2(a)-FIG. 2(d) show honeycomb structures for fuel cell applications. The honeycomb cells may include square, hexagonal, and other polygonal shapes. In FIG. 2(a), shaded cells 19 aligned along the dotted line A. Open cells 20 aligned along the dotted line B. The shaded cells along the line A and the open cells along the line B alternate in a format of ABAB. For example, the shaded cells 19 may be considered as fuel channels and the open cells 20 may be considered as air channels. Each wall between fuel and air channels form an electrolyte cell that generates electromotive force. The honeycomb structure that forms these channels and walls comprise a group of fuel cells. These fuel cells may be connected each other in parallel or series.

FIG. 2(b) shows honeycomb square cells. The shaded cells 21 and open cells 22 alternate along the dotted line A′. Open cells along the dotted line B alternate with mixed cells along the dotted line A′ in a format of A′BA′B.

FIG. 2(c) shows an example of a combination of channels for fuel, air, fuel preheating, air preheating, fuel exhaust, and air exhaust. Cells 21a may be considered, for instance, fuel channels, cells 22a may be considered air channels, cells 21b preheated air channels, cells 22b preheated fuel channels, cells 21c depleted fuel exhaust channels, and cells 22c spent air exhaust channels. The gas preheating channels and exhaust gas channels, 21b, 22b, 21c, 22c, are intervened with fuel and air channels 21a and 22a for heat exchange.

FIG. 2(d) shows honeycomb hexagonal cells. The shaded cells 23 are separated by open cells 24. The walls between these channels form fuel cells. The hexagonal honeycomb structure forms a group of such fuel cells. Other polygonal cells may also be constructed in the same fashion, such as, triangular cells.

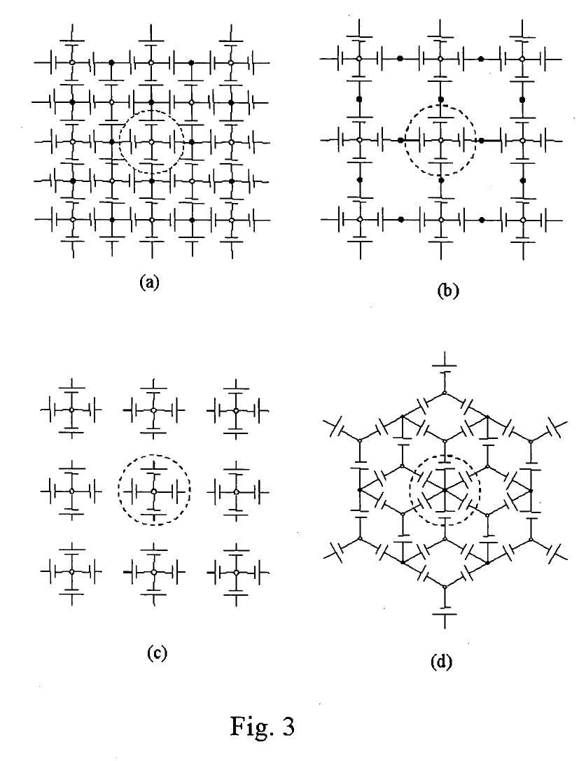

Presumably, honeycomb substrate material is electrically insulating. FIG. 3(a)-FIG. 3(d) show equivalent circuits for corresponding honeycomb structures as shown in FIG. 2(a)-FIG. 2(d), respectively.

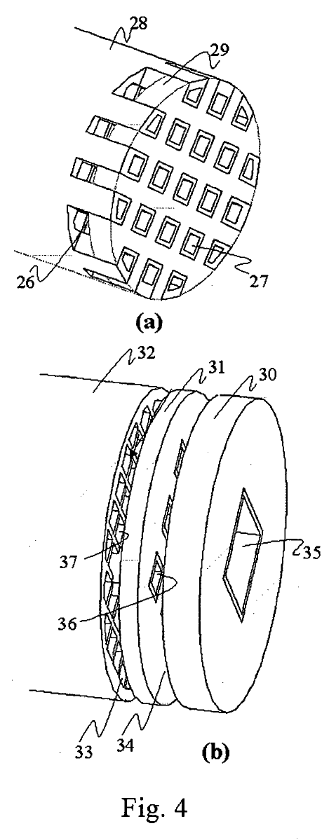

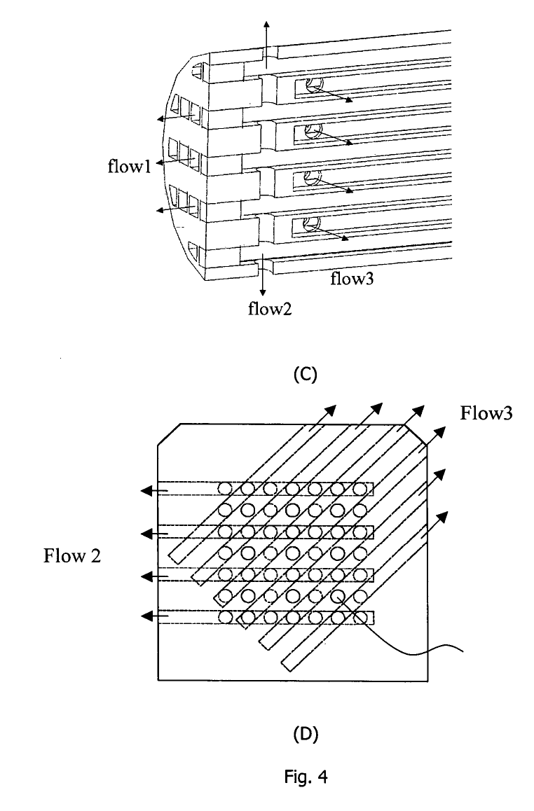

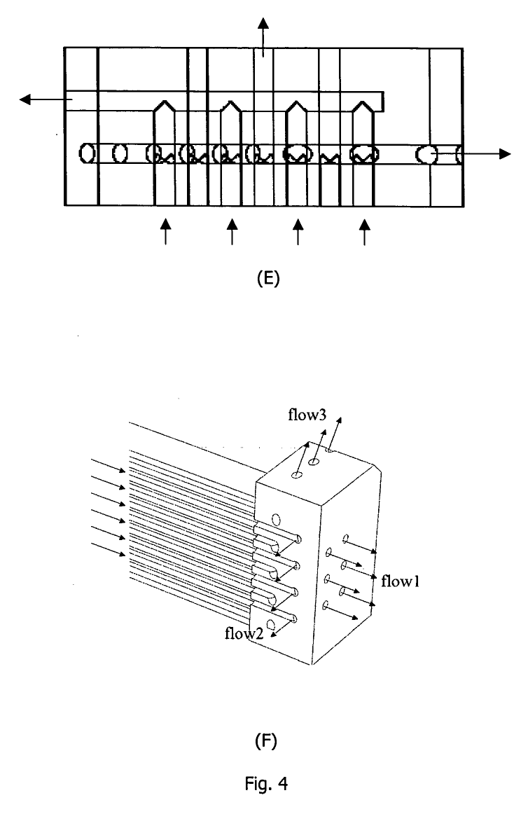

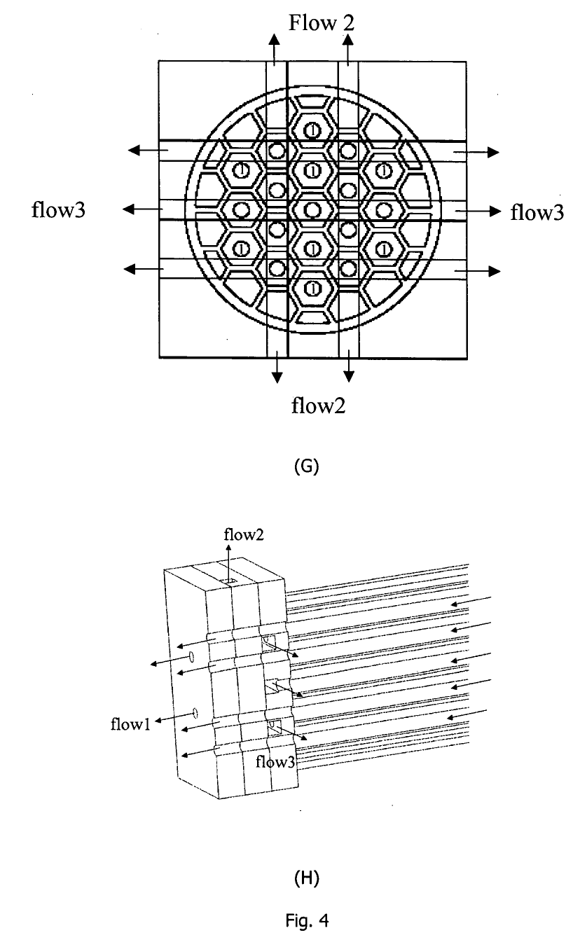

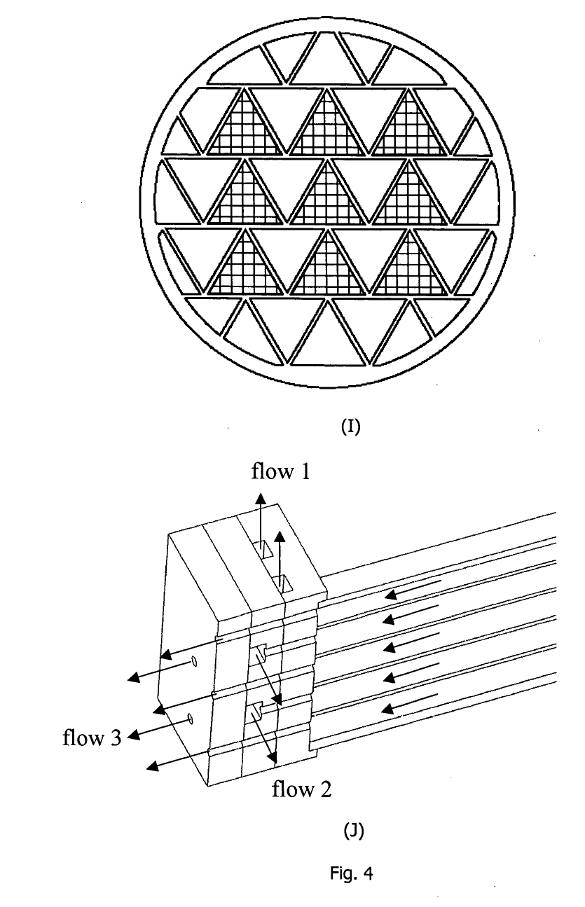

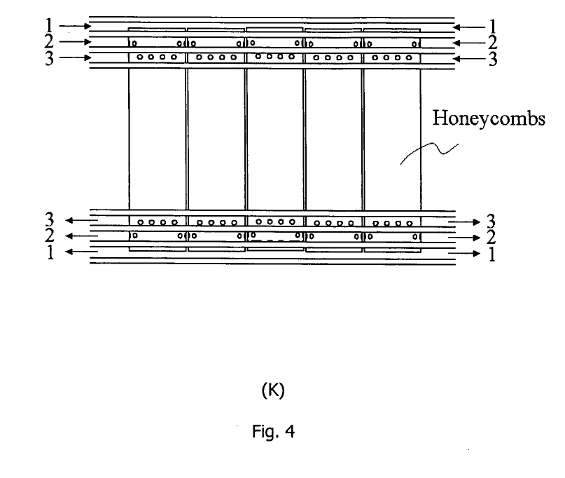

FIG. 4(a)-FIG. 4(b) show honeycomb fuel cell manifold structures. FIG. 4(a) shows a simple honeycomb manifold which allows one gas flow through the openings 27 and allows another gas flow through the side openings 26. FIG. 4(b) shows a manifold which forms three independent gas entrances. One gas flows through the opening 35. Another gas flows through the side openings 34 and 36. A third gas flows through the side openings 33 and 37. More complicated manifold can be formed in a similar fashion for multiple gas passageways. These openings can be gas outlets or inlets or any combinations of gas outlets and inlets. This allows preheating fuel, preheating air, supplying fuel, supplying air, depleted fuel recycle, and spent air to exhaust in their own channels without being mixed. FIG. 4(c) illustrates another fashion of manifold for 3 gas passageways in a square honeycomb. One gas passageway is through the honeycomb channels as shown as flow 1 per FIG. 4(b). The second gas passageway is through the perpendicular channels to the honeycomb channels as shown as flow 2 in FIG. 4(c). The third gas passageway is perpendicular to both flow 1 and flow 2 and as shown in FIG. 4(c). As seen in Fib. 4(c), the perpendicular channels may be provided by the through holes. The honeycomb channels which connect to those perpendicular channels are blocked at ends. This converges honeycomb channels to three groups of channels. Each group of channels have their own directions which may separate the gas openings apart and make gas passageway interconnections easy. FIG. 4(D)-(F) describe another manifold. FIG. 4(D) is a front view of the manifold for honeycombs with square channels. The manifold has one to one corresponding channels to interconnect with the honeycomb channels. Some of the channels labeled “flow 1” as shown in FIG. 4(D) may directly lead the honeycomb channels to the manifold openings. Some of the honeycomb channels as predetermined may be combined by channels perpendicular to the honeycomb channel direction. The perpendicular channels lead to the openings denoted as “flow 2” as shown in FIG. 4(D). Some of the channels are combined by diagonal channels which are perpendicular to the honeycomb channels and in angle of 45 degrees with the perpendicular channels. The diagonal manifold channels lead to the side openings denoted as “flow 3” as shown in FIG. 4(D). These channels are perpendicular to the honeycomb channels but with 135 angles with flow 2 channels. The manifold channels may not be limited by any shapes. The round channels shown in the drawings are for illustrative and simplicity purpose. Manifold channels may not be limited by three as shown in the drawings. Higher channel count manifolds are possible. Again, for simplicity and illustrative purpose, I use three or less groups of manifold channels for descriptions and explanations. FIG. 4 (E) shows the manifold side view. All of the honeycomb channels have one-to-one interconnection with manifold channels. However, these manifold channels have three levels of depths. The first depth is through holes which form “flow 1” channels as shown in FIG. 4(D-E). The second level of manifold channel depth exits to the side openings “flow 2” via perpendicular channels as shown in FIG. 4(D-E). The third level of manifold channel depth exits to the side openings “flow 3” via perpendicular channels as show in FIG. 4(D-E). The FIG. 4(F) shows the 3-D manifold which further describes the channel interconnections between manifold and honeycomb and manifold internal channel structures as well. For SOFC applications, the manifold may be made of ceramics, e.g. Al₂O₃ or cordierite. In other applications, high purity Al₂O₃ is used as high temperature molten metal filtering and cordierite is used in automotive catalytic converters. For honeycomb fuel cells, manifold may also provide electrical interconnections between electrodes. This requires that a manifold shall be made as a substrate for continuous electrical leads without short circuit. One may use wash coating to deposit electrical conductor layers utilizing selective grouped manifold channels. FIG. 4(G)-(H) demonstrate a manifold for hexagonal honeycomb fuel cells. The manifold channel group 1 is perpendicular to the paper and denoted as “1” for each of its openings as seen in FIG. 4(G). These channels are straight with and connected to the honeycomb structure channels. The manifold channel group 2 is perpendicular to the honeycomb fuel cell channels and have openings across the manifold from the top to the bottom which are denoted as “flow 2” as seen in FIG. 4(G). The manifold channel group 3 is perpendicular to both of the channel group 1 and 2. It has the similar configurations to the channel group 2. As seen in FIG. 4(H), the manifold may be made of individual slabs. For each slab, selective through holes and grooves may made to interconnect the predetermined channels. A manifold may be provided using combinations of these slabs with different patterns of through holes and grooves for various channel shapes and gas passageways of honeycomb fuel cells. These slabs may be combined by seals. These slabs and manifold can be further extended for multiple honeycombs for gas passageways and electrical interconnections. FIG. 4(I)-(J) shows similar manifold configurations for triangle honeycomb channels. FIG. 4(K) illustrates interconnections among multiple honeycombs. The structure may be dependant upon the manifold configurations and design requirements for gas and electrical interconnection. Electrically conductive seals may be a good choice for adhesion between a manifold and honeycomb, gas leak proof, and electrical interconnections.

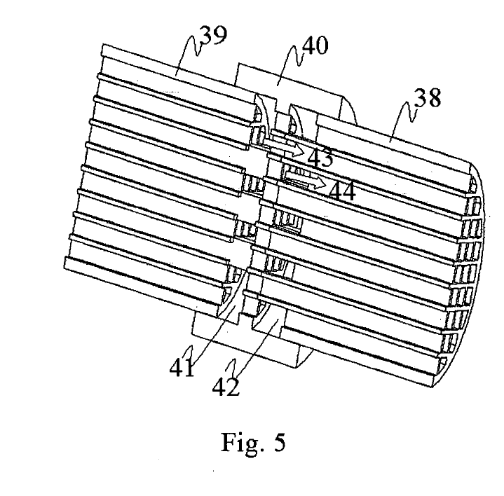

FIG. 5 shows a manifold which allows two gases from honeycomb 39 to enter into honeycomb 38 via manifold 40 without being mixed. Presumably, the manifold 40 is electrically conductive either in bulk or by surface coated electrical layers. The manifold serves an electrical interconnect between the honeycomb 38 and 39 in addition to maintaining gas passageways.

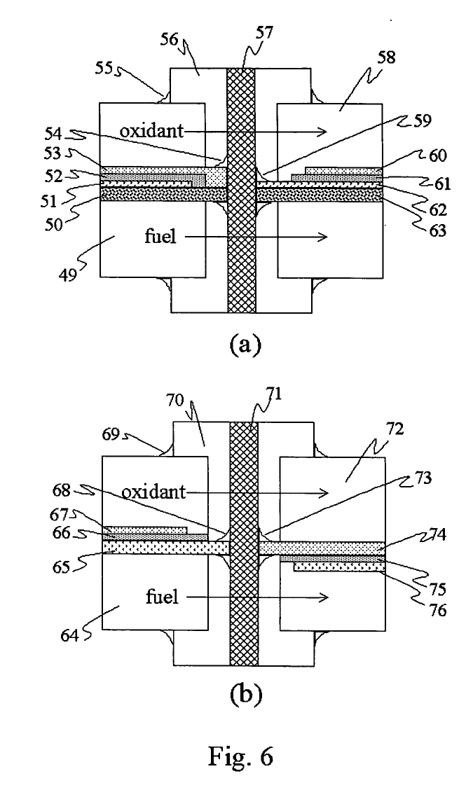

FIG. 6(a) illustrates an electrical interconnection configuration via manifold. Honeycomb 49 and honeycomb 58 are mechanically jointed by a manifold 56. Air and fuel gas flow through the aligned channels in 49 and 58. Part 50 is a porous support for an anode layer 51, an electrolyte layer 52, and a cathode layer 53 in honeycomb structure 49. Part 63 is a porous support for an anode layer 62, an electrolyte layer 61, and a cathode 60 in honeycomb structure 58. Part 57 is an electrical interconnection slab of manifold 56. The manifold 56 can be metallic or surface coated or partially coated with an electrical conducting layer. It is noticed that a cathode layer 53 is connected with an anode layer 62 via manifold slab 57. It is also noticed that the cathode 53 and 62 can be directly interconnected with seals 54 and 59 without the manifold slab 57. In this case, the manifold 56 without the slab 57 serves as mechanical support and alignment for the honeycombs 49 and 58. The electrical interconnection is sealed with an electrical conductive seal 54 and 59. Seal 55 is to seal manifold 56 and honeycomb structures 49 and 58. The porous support 50 for anode can be embedded with catalysts for hydrocarbon reform.

FIG. 6(b) illustrates an electrical interconnection configuration via manifold. Honeycomb 64 and honeycomb 72 are mechanically jointed by a manifold 70. Air and fuel gas flow through the aligned channels in 64 and 72. Part 65 is a porous anode which supports an electrolyte layer 66 and a cathode layer 67 in honeycomb structure 64. Part 74 is a porous cathode which supports an electrolyte layer 75 and an anode layer 76 in the honeycomb structure 72. Part 71 is an electrical interconnection slab of manifold 70. The manifold 70 can be metallic or surface coated or partially coated with an electrical conducting layer. It is noticed that an anode support 65 is connected with an cathode support 74 via manifold slab 71. It is also noticed that the anode 65 and cathode 74 can be directly interconnected with seal 68 and 73 but without the manifold slab 71. In this case, the manifold 70 without the slab 71 serves as mechanical support and alignment for the honeycombs 64 and 72. The electrical interconnection is provided with an electrical conductive seal 68 and 73. Seal 69 is to seal manifold 70 and honeycomb structures 64 and 72. The porous anode 65 can be used for direct hydrocarbon oxidation.

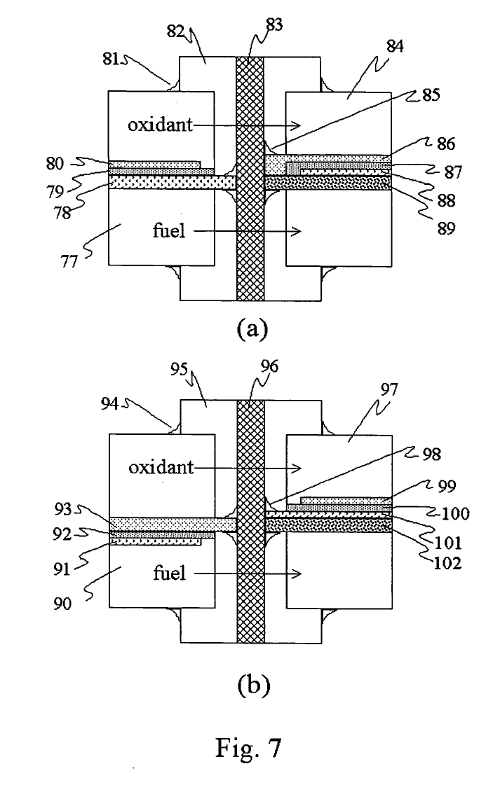

FIG. 7(a) illustrates an electrical interconnection configuration via manifold. Honeycomb 77 and honeycomb 84 are mechanically jointed by a manifold 96. Air and fuel gas flow through the aligned channels in 77 and 84. Part 78 is a porous anode which also supports an electrolyte layer 79 and a cathode layer 80 in the honeycomb structure 77. Part 89 is a porous support for an anode layer 88, an electrolyte layer 87, and a cathode layer 86 in the honeycomb structure 84. Part 83 is an electrical interconnection slab of manifold 82. The manifold 82 can be metallic or surface coated or partially coated with an electrical conducting layer. It is noticed that an anode support 78 is connected with an cathode layer 86 via manifold slab 83. It is also noticed that the anode 78 and cathode 86 can be directly interconnected with seal 85 without the manifold slab 83. In this case, the manifold 82 without the slab 83 serves as mechanical support and alignment for the honeycomb structures 77 and 84. The electrical interconnection is secured with an electrical conductive seal 85. Seal 81 is to seal manifold 82 and honeycomb structures 77 and 84. The porous anode 78 can be used for direct hydrocarbon oxidation. The porous support 89 for anode can be embedded with catalysts for hydrocarbon reform.

FIG. 7(b) illustrates an electrical interconnection configuration via manifold. Honeycomb 90 and honeycomb 97 are mechanically jointed by a manifold 95. Air and fuel gas flow through the aligned channels in both 95 and 97. Part 93 is a porous cathode which supports an anode layer 92 and a cathode layer 91 in honeycomb structure 90. Part 102 is a porous support for an anode layer 101, an electrolyte layer 100, and a cathode layer 99 in the honeycomb structure 97. Part 96 is an electrical interconnection slab of manifold 95. The manifold 95 can be metallic or surface coated or partially coated with an electrical conducting layer. It is noticed that an cathode support 93 is connected with an anode layer 101 via manifold slab 96. It is also noticed that the cathode 93 and anode 101 can be directly interconnected with seal 98 without the electrical interconnecting slab 96. In this case, the manifold 95 without the slab 96 serves as mechanical support and alignment for the honeycomb structures 90 and 97. The electrical interconnection is secured with an electrical conductive seal 98. Seal 94 is to seal manifold 95 and honeycombs 90 and 97. The porous support 102 for anode can be embedded with catalysts for hydrocarbon reform.

1. A solid electrolyte fuel cell element comprises:
a honeycomb structure with plural open channels that interconnect channel walls forming parallel channels extended from a first face to a second face of the honeycomb shape; and
a manifold with plural open channels interconnecting the said honeycomb structure with predetermined channel patterns that combine the honeycomb channels in a selective fashion; change directions of the said honeycomb channels; and lead the combined channels to predetermined openings.

2. A solid electrolyte fuel cell element in accordance with claim 1 wherein the manifold interconnects the channels of said honeycomb structure forming connected channels in parallel or serial or in a combination of both.

3. A solid electrolyte fuel cell element in accordance with claim 1 wherein a manifold interconnecting the said honeycomb channels with the first honeycomb interconnects with a second honeycomb structure in parallel or serial or in a combination of both.

4. A solid electrolyte fuel cell element in accordance with claim 1 wherein the manifold electrically interconnects a cathode or an anode within said honeycomb structure or with another honeycomb structure in a predetermined fashion.

5. A solid electrolyte fuel cell element in accordance with claim 1 wherein the channel shapes of a honeycomb and a corresponding manifold comprises square, hexagonal, triangle, or a combination of the above with shared channel walls.

6. A solid electrolyte fuel cell assembly comprising the element in accordance with claim 1 utilizes:
channels for a fuel, hydrogen or hydrocarbon;
channels for an oxidant, air or hydrogen peroxide; and
channels for depleted fuels, oxidants, fuel oxidation products, steam, or water.

7. A solid electrolyte fuel cell assembly comprising the element in accordance with claim 1 incorporates in said honeycomb structure a combustor, a heat exchanger, a fuel reformer, a water condenser, or a water recycle system.

8. A solid electrolyte fuel cell assembly utilizes a solid electrolyte fuel cell element in accordance with claim 1 to incorporate multiple honeycomb structures to form a fuel cell stack.

9. A solid electrolyte fuel cell element in accordance with claim 1 wherein the honeycomb manifold is composed of:
a substrate of a porous electrode material;
an insulating layer; and
a counter-electrode layer.

10. A solid electrolyte fuel cell element in accordance with claim 1 wherein the honeycomb manifold is composed of:
a substrate of a porous insulating material;
an electrode layer;
an electrical insulating layer; and
a counter-electrode layer.

11. A fuel reformer element comprises:
a honeycomb structure with plural open channels that interconnect channel walls forming parallel channels extended from a first face to a second face of the honeycomb shape; and
a manifold with plural open channels interconnecting the said honeycomb structure with predetermined channel patterns that combine the honeycomb channels in a selective fashion; change directions of the said honeycomb channels; and lead the combined channels to predetermined openings.

12. A fuel reformer element in accordance with claim 11 wherein the manifold interconnects the channels of said honeycomb structure forming connected channels in parallel or serial or in a combination of both.

13. A fuel reformer element in accordance with claim 11 wherein a manifold interconnecting the said honeycomb channels with the first honeycomb interconnects with a second honeycomb structure in parallel or serial or in a combination of both.

14. A fuel reformer element in accordance with claim 11 wherein the channel shapes of a honeycomb and a corresponding manifold comprises square, hexagonal, triangle, or a combination of the above with shared channel walls.

15. A fuel reformer assembly comprising the element in accordance with claim 11 utilizes:
channels for a fuel, hydrogen or hydrocarbon;
channels for an oxidant, air or hydrogen peroxide; and
channels for depleted fuels, oxidants, fuel oxidation products, steam, or water.

16. A fuel reformer assembly comprising the element in accordance with claim 11 incorporates in said honeycomb structure a combustor, a heat exchanger, a water condenser, or a water recycle system.

17. A fuel reformer assembly utilizes element in accordance with claim 11 to incorporate multiple honeycomb structures to form a fuel cell stack.

18. A method of making a fuel cell honeycomb manifold element comprises steps of:
providing a porous honeycomb electrode substrate;
providing perpendicular channels in a predetermined fashion;
providing blocking on selectively honeycomb channels;
providing an insulating layer on said honeycomb electrode substrate; and
providing a counter-electrode layer.

19. A method of making a fuel cell honeycomb manifold element in accordance with claim 18 composes steps of:
providing a porous honeycomb electrode substrate;
providing perpendicular channels in a predetermined fashion;
providing blocking on selectively honeycomb channels;
providing an insulating layer on said honeycomb electrode substrate; and
providing a counter-electrode layer.

20. A method of making a fuel reformer manifold element in accordance with claim 18 composes steps of:
providing a porous honeycomb substrate of inert materials;
providing perpendicular channels in a predetermined fashion; and
providing blocking on selectively honeycomb channels.
